(19) United States
(12) Patent Application Publication
(10) Pub. No.: US 2012/0061550 A1
(43) Pub. Date: Mar. 15, 2012

(54) Wall hanger assembly including security feature and installment aid

(76) Inventor: Joseph F. Hickey, Morristown, NJ (US)

(21) Appl. No.: 12/807,583

(22) Filed: Sep. 10, 2010

(51) Int. Cl. A47G 1/16; F16M 13/02

(52) U.S. Cl. 248/475.1; 248/223.41

(57) ABSTRACT

An improved hanger for mounting mirrors and pictures mounted in frames, and in particular, heavy mirrors and heavy pictures mounted in frames, the improved hanger having a top end and a bottom end, the top end having a groove disposed parallelledly to the wall on which the mirror or picture mounted in a frame is to be hung, the groove having a flared opening and parallel side walls terminating in a flat bottom wall having arcuate edges where the bottom wall intersects the side walls of the improved hanger, the improved hanger having at least one diagonal aperture there through for the receipt of a fastening means and one or more horizontal countersunk apertures for receipt of a fastening means.

### BACKGROUND OF THE INVENTION

1. Field of the Invention

This invention relates to hangers that are attached to walls for supporting objects such as mirrors and pictures mounted in frames, and it particularly relates to hangers utilized for hanging heavy mirrors and pictures mounted in frames by means of a fastener which passes through the improved hanger and into the wall.

2. Description of the Prior Art

Applicant is the holder of U.S. Pat. No. 5,482,244 for a hanger attached to a wall for supporting objects such as mirrors and pictures mounted in frames. The '244 patent discusses the prior art known to the Applicant at the time of the filing of that application, and it is incorporated herein.

The improved hanger incorporates improved structure developed by the Applicant through testing and use, and in particular, for the support of larger and heavier mirrors and pictures mounted in frames and further addresses safety issues with respect to these heavier objects mounted on walls.

In addition, Applicant's improved hanger incorporates a security, anti-theft device to prevent the hanging object from being removed from the hanger, and hence the wall, by an unauthorized individual.

Applicant's improved hanger has application to mirrors and pictures mounted in frames which may have taut wires stretched across their frames for hanging, and also to mirrors and the pictures mounted in frames which utilize a saw-tooth hanging clip for mounting.

The improved hanger of the present invention can also be used with a novel installation guide strip for locating the desired position of the mirror or picture in a frame on a wall and allowing for the marking of the exact position where the improved hanger should be secured to insure the accuracy of the positioning of the object to be hung.

### OBJECTS OF THE INVENTION

An object of the present invention is to provide for a novel improved hanger for mirrors and pictures mounted in frames which will safely support heavy mirrors and pictures mounted in frames.

It is another object of the present invention to provide for a novel improved hanger for mirrors and pictures mounted in frames in which the hanger can support mirrors and pictures mounted in frames which are hung by a taut wire or by a saw-toothed hanging clip.

It is a still further object of the present invention to provide for a novel improved hanger for mirrors and pictures mounted in frames in which when mounted, neither the improved hanger, the taut metal wire, or the saw-toothed hanging clip are visible.

It is a further object of the present invention to provide for a novel improved hanger for mirrors and pictures mounted in frames which provides stability to the mirror or picture mounted in frame.

It is a further object of the present invention to provide for a novel improved hanger for mirrors and pictures mounted in frames, which includes a security device which prevents the unauthorized removal of the object from the hanger.

It is a still further object of the present invention to provide for a novel improved hanger for mirrors and pictures mounted in frames which improved hanger is cooperative with an installation guide strip to insure the accurate location of the object on the wall and the exact location of the improved hanger for such installation.

### SUMMARY OF THE INVENTION

An improved hanger for mounting mirrors and pictures mounted in frames, and in particular, heavy mirrors and heavy pictures mounted in frames, the improved hanger having a top end and a bottom end, the top end having a groove disposed parallelledly to the wall on which the mirror or picture mounted in a frame is to be hung, the groove having a flared opening and parallel side walls terminating in a flat bottom wall having arcuate edges where the bottom wall intersects the side walls of the improved hanger, the improved hanger having at least one diagonal aperture there through for the receipt of a fastening means and one or more horizontal countersunk apertures for receipt of a fastening means.

### BRIEF DESCRIPTION OF THE DRAWINGS

These and other objects of the present invention will become apparent, particularly when taken in light of the following illustrations wherein:

FIG. 1 is a side elevational view of the improved hanger of the present invention;

FIG. 2 is a top view of the improved hanger of the present invention;

FIG. 3 is a front view of the improved hanger of the present invention;

FIG. 4 is a front view of a second embodiment of the improved hanger of the present invention incorporating a security device;

FIG. 5 is a side view of FIG. 4;

FIG. 6 is a side exploded view of FIG. 4;

FIG. 7 is a side view of a second embodiment of the security device;

FIG. 8 is a front view of a second embodiment of the security device; and

FIG. 9 is a front view of an installation guide strip.

### DETAILED DESCRIPTION OF THE INVENTION

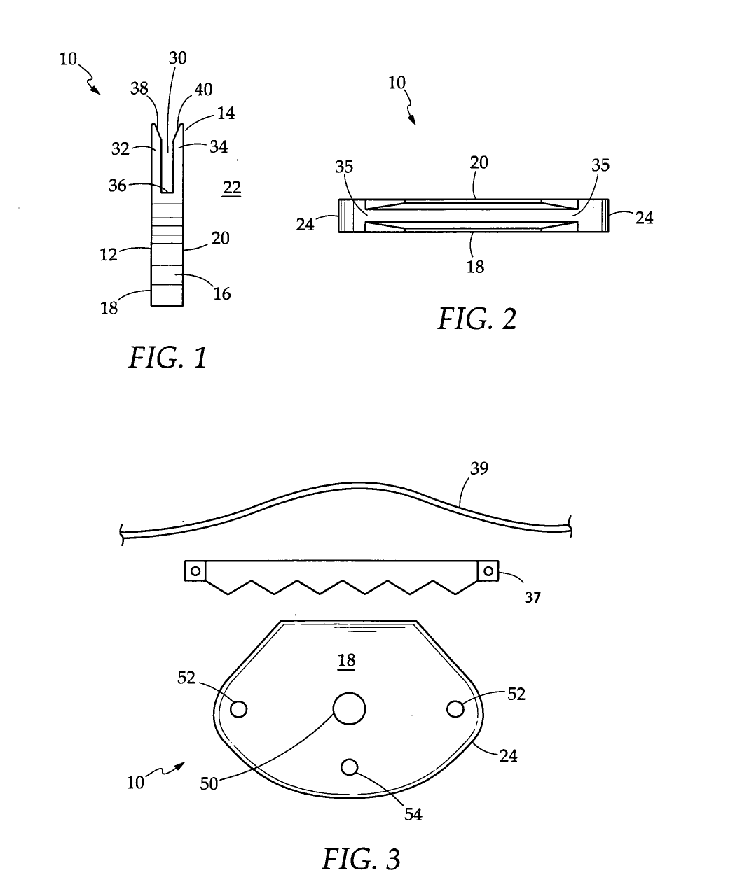

FIG. 1 is a side elevational view of the improved hanger of the present invention, FIG. 2 is a top view, and FIG. 3 is a front view. The improved hanger 10 has a body portion 12 defined by an upper groove portion 14 and a lower support portion 16. Body portion 12 is further defined by a front face 18, and a rear face 20, which will juxtapose the wall 22 of a room onto which the improved hanger 10 is positioned in order to support a mirror or picture mounted in a frame. The improved hanger 10 also is defined by a peripheral side wall 24.

The improvement to the groove portion 14 of improved hanger 10 is with respect to the cross-section of the groove portion itself as more fully illustrated in FIGS. 1 and 2. The groove portion is no longer a V-cut in cross-section across the upper peripheral wall of the improved hanger 10, but now consists of a groove or a slot 30 having parallel side walls 32 and 34 and a bottom wall 36. The side walls 32 and 34 are flared or beveled outwardly 38 and 40 at their upper terminus. Still further, the bottom wall 36 is planar and at its terminal intersections 38 and 40 with the peripheral side wall 24, the bottom wall 36 is arcuate or rounded 35 at its intersection with the peripheral side wall thereby eliminating any angled intersection which could abrade a wire.

The width of the groove or slot 30 is sufficient to receive the saw tooth horizontal portion of a hanging clip 37 attached to the top frame member of a picture mounted in a frame or a mirror and at the same time is adapted to accept a picture wire 39 attached to a picture frame. The flared upper portion 38 and 40 of groove or slot 30 allows for the facile positioning and engagement of either type of hanging device into groove or slot 30. The curvature of the terminus of the intersection of the planar bottom wall 36 with the peripheral side walls 24 eliminates any sharp edges with respect to a wire attachment and eliminates any unwanted pressure points either on the wire attachment itself or the pressure exerted by the wire onto the hanger as a result of the weight of the attached mirror or picture mounted in a frame.

The improved hanger 10 of the present invention is secured to the wall and stabilized by a plurality of apertures formed in the support portion 16. A centrally disposed aperture 50 which is countersunk is the largest aperture and dimensioned to receive wall plugs, toggles, or other wall fasteners which substantially increase the weight capacity of the improved hanger and minimize safety concerns. The countersunk aperture allows the head of the fastener to be recessed allowing the hanging object to be flush with the wall. Disposed on either side of central aperture 50 are a pair of 45 degree countersunk nail holes 52, preferably in the same alignment with centrally disposed aperture 50. Positioned below centrally disposed aperture 50 is a third countersunk nail hole 54 which is disposed perpendicularly through support portion 16.

The wall plug, toggle, or other wall fastener utilized with centrally disposed aperture 50 provides the increased weight bearing capacity. The two 45 degree countersunk nail holes 52 provide additional weight bearing capacity while the countersunk nail hole 54 provides the rotational stability to the improved hanger 10. When the improved hanger 10 is attached to a wall, it is sufficiently elevated that it easily fits into a groove between saw teeth of a picture hanging clip that is attached to the top frame member of a picture, or the like, thereby being hidden from view. It is also well adapted to accept a picture wire attached to a picture frame, and because of the flat planar bottom of the groove, and the rounded edges, minimize any tendency for the wire to slip sideways and cause the picture frame to tilt. Its use with a wire frame also permits it to be hidden from view.

Improved hanger 10 is manufactured from a polymer, such as propylene, epoxy, nylon, or polycarbonate. It is inexpensive to manufacture, light in weight, yet strong and rigid. Improved hanger 10 as illustrated, is generally ovoid in shape having a flattened upper groove end. It will be recognized by those of ordinary skill in the art that the body portion shape may vary.

Improved hanger 10 can also be produced in a range of sizes for supporting picture or mirror frames of a variety of sizes and weights. Generally, the greater the surface area of the support portion 16, the greater weight can be supported. Further, having the groove or slot 30 close to the wall is advantageous when supporting very small pictures, because the picture will be able to hug the wall. However, it is also extremely advantageous when supporting a very heavy picture or mirror because the shape of the improved hanger and the size of the support portion 16 minimize pivoting forces on the fasteners.

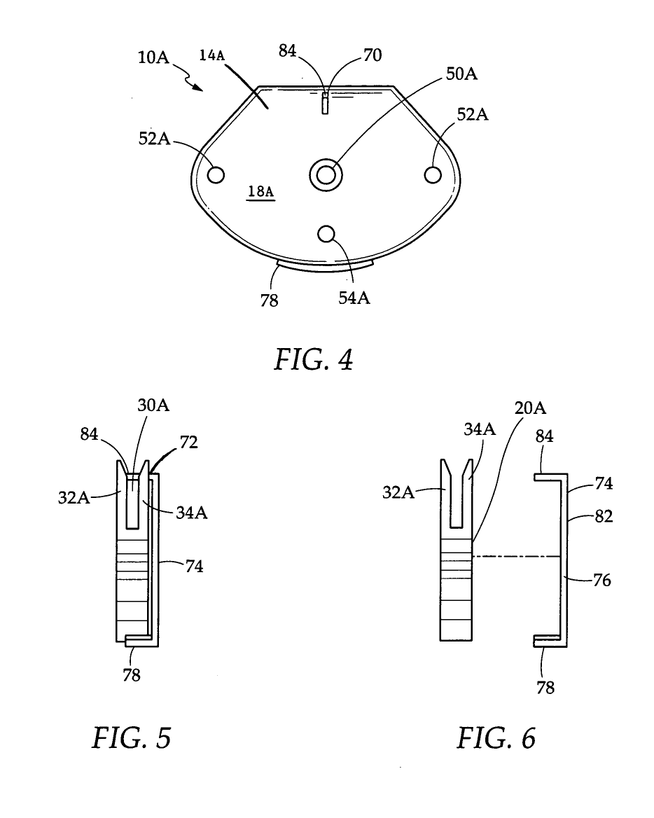

FIGS. 4, 5, and 6 are a front view, side view and side exploded view of a second embodiment of the improved hanger 10A of the present invention which exhibits slight modifications in order to incorporate a security device which prevents the unauthorized removal or theft of a picture, mirror, or other object which is supported by the improved hanger 10A. The modification to the improved hanger 10A includes alignable apertures 70 and 72 formed in parallel side walls 32A and 34A of groove portion 14A. A security plate 74 preferably formed of metal having a peripheral circumference 76 coincidental with the periphery of the improved hanger 10A, and having a bottom planar surface 78 is interposed between the rear face 20A of improved hanger 10A and the wall. Security plate 74 has a plurality of apertures there through which when so positioned, align with the apertures 50A, 52A, and 54A through support portion 16A of improved hanger 10A. The upper end 82 of security plate 74 includes a protruding finger 84 which engages in the aligned apertures 70 and 72 in side walls 32A and 34A of groove portion 14A. The improved hanger 10A and security plate 74 would be affixed to the wall in the manner previously described. The finger member 84 of security plate 74 is formed of spring steel. When the saw tooth clip 37 or the taut wire 39 of a picture frame or mirror or other object is pressed or pushed downwardly into groove or slot 30A, finger member 84 is displaced downwardly allowing for the saw tooth clip 37 or taut wire 39 to pass below the finger member 84 and engage or rest on bottom wall 36A of groove portion 14A. Finger member 84 after the passage of the taut wire or saw tooth clip, rebounds or returns to its original position and is engaged against the circumferential wall of the aperture 70 formed in the front face 18A of groove portion 14A, thus providing a stop which prevents the picture, frame, or other object from being lifted out of the improved hanger 10A.

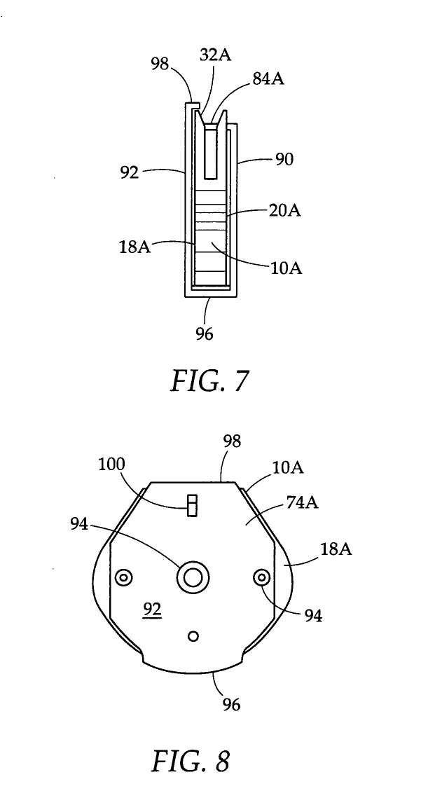

FIG. 7 is a side view and FIG. 8 is a front view of another embodiment of the security device illustrated in FIGS. 4, 5, and 6. The security device of FIGS. 7 and 8 serves the same purpose as the security device as illustrated in FIGS. 4, 5, and 6. However, the security device in FIGS. 7 and 8 partially encapsulates the improved hanger 10A. The metal security plate 74A as illustrated in FIGS. 7 and 8, has a rear face 90 interposed between rear face 20A of improved hanger 10A, and the wall, and has a front face 92 which overlies the front face 18A of improved hanger 10A. Both the front face 92 and the rear face 90 have a plurality of aligned apertures 94 which are alignable with the apertures in the improved hanger 10A. Front face 92 and rear face 90 are connected by a lower wall 96 which engages the lower periphery of hanger 10A. The front face 92 of security plate 74A has an upper lip 98 which overlaps the upper surface of side wall 32A of groove portion 14A. Proximate this upper lip 98, is a vertical longitudinal aperture 100 which engages finger member 84A extending forwardly from rear face 90 of security plate 74A. Aperture 100 is aligned with apertures 70A and 72A in side walls 32A and 34A. The purpose of security plate 74A and its operation are identical to the embodiment illustrated in FIGS. 4, 5, and 6. The saw-tooth clip or taut wire attached to the object to be hung, is allowed to pass downwardly displacing finger member 84A until the saw-tooth clip or taut wire is engaged in the groove or slot 14A. The finger member 84A is then allowed to spring backwardly into a horizontal position and be lockingly engaged with the apertures formed in the front face of the security plate 74A.

It should be noted that the security plate embodiment of the hanger of the present invention is an optional embodiment of the hanger. The hanger may be used with or without the security plate. The use of the security plate would be within the purview of the purchaser depending upon the intended use and location of the hanger.

The improved hanger of the present invention may also be used with an installation strip which allows for individuals to accurately locate and identify the positioning of the object to be hung prior to any apertures or holes being made in the wall surface. It will be recognized by those of ordinary skill in the art that the location of the hook or the hanger upon which an object will hang on a wall is difficult to gauge or measure, particularly when the object to be hung is to be hung by a taut wire, which is not necessary taut. Oftentimes individuals have to make and repair multiple apertures or holes in the walls with fasteners to correctly locate the position and height of the hanger in order to obtain the desired positioning of the object to be hung.

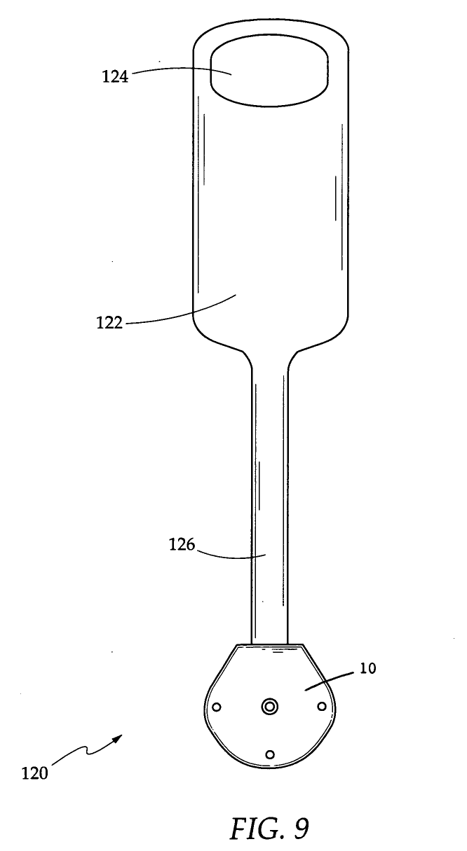

FIG. 9 is a front view of an installation strip which forms part of Applicant's assembly for accurately hanging an object. The installation strip 120 can be made of any suitable rigid material. It contains an upper end 122 which is the handle end, and may include an aperture 124 for the insertion there through of one or more fingers. Extending downwardly from the handle end 122, is a longitudinal strip 126 which is rigidly secured to the handle end 122. A first improved hanger 10 of the present invention is fixedly secured to this strip by a plurality of fasteners. A second improved hanger 10 of the present invention is further secured to this longitudinal strip at a point below the first improved hanger.

In use, an individual would grip the installation strip 120 by handle end 122. The object to be hung would be positioned on one of the improved hangers 10. The choice of which improved hanger depends on the size of the object, the type of hanging mechanism, taut wire, or saw-tooth clip, and the distance between the saw-tooth clip or taut wire and the top of the object.

For a light weight object, the user would position the installation strip 120 against the wall and hang the object from the desired improved hanger 10. Utilizing the handle end 122, the user can manipulate the object up, down, left or right in response to the eye of a observer viewing the object on the wall. Once the observer identifies the correct location, the painting is removed from the improved hanger, while the installation strip remains held in its final location. The holder or observer can then mark the location of the improved hanger that is secured to the installation strip in relationship to the adjacent wall by making slight hash marks along its periphery. The user can then use an identical improved hanger and affix it to the wall at that location so that the object may be hung in the position desired. For light objects the installation may require only two individuals, a user/holder, and an observer. For heavier objects, the individual holding the installation strip may not be able to support the object if it is heavy, and thus the installation may require a user holding the installation strip, and one or more assistants providing aid in elevating the object while the observer corrects the positioning. Thereafter, the process remains the same. The assistants would remove the painting, the observer or user would mark the location of the improved hanger affixed to the longitudinal strip by making indicia against the adjacent wall, and then the appropriate sized improved hanger would be affixed to the wall at that location.

Therefore, while the present invention has been disclosed with respect to the preferred embodiments thereof, it will be recognized by those of ordinary skill in the art that various changes and modifications can be made without departing from the spirit and scope of the invention. It is therefore manifestly intended that the invention be limited only by the claims and the equivalence thereof.

I claim:

1. An improved hanger fabricated of polymer for hanging heavy objects from a wall, the improved hanger comprising:
a body portion having a front face, and a rear, wall engaging face, said body portion having an upper groove portion and a lower support portion;
said groove portion having an elongated groove parallel to said wall surface, said groove defined by two vertical parallel walls terminating in a bottom wall, said parallel walls being beveled at an upper terminus, said bottom wall having rounded end termini where said bottom wall merges with a peripheral side wall of said improved hanger, said groove dimensioned to accept a saw toothed hanging clip, or a taught wire utilized to hanging objects;
said support portion of said body portion having a centrally disposed countersunk aperture for receipt of a heavy duty fastener, such as a toggle bolt, there being disposed on both sides of centrally disposed aperture, a countersunk diagonal aperture for receipt of a nail support, there being disposed below said centrally disposed aperture, a perpendicular aperture for receipt of a stabilizing nail fastener.

2. The improved hanger of claim 1, wherein said polymer is selected from a group comprising polypropylene, epoxy nylon, and polycarbonate.

3. The improved hanger of claim 1, wherein said improved hanger includes longitudinal vertically aligned apertures in said side walls of said groove to accommodate a security device, said security device comprising a planar panel coextensive with said rear face of said improved hanger, said panel having an extending lower surface engagable with a lower periphery of said improved hanger, said panel having an extending upper finger engagable in said longitudinal vertical apertures in said side walls of said groove, said panel having a plurality of apertures alignable with said apertures of said support portion of said improved hanger, said security panel positioned between said wall and said rear face of said improved hanger secured to said wall.

4. The improved hanger in accordance with claim 3, wherein said outwardly extending upper finger of said security panel is resiliently deformable from a horizontal position to a downward vertical position and returnable to said horizontal position, permitting the downward passage of a saw toothed clip or taut wire for hanging an object on said improved hanger, said finger returnable from said vertical downward position to said horizontal position preventing removal of said objects so hung.

5. The improved hanger in accordance with claim 4, wherein said security panel and said upper horizontally extending finger are formed of spring steel.

6. The improved hanger in accordance with claim 1 wherein said improved hanger is fixedly secured to a location strip, said location strip comprising a vertical strip member having said improved hanger fixedly secured at a lower end, an upper end having a handle end formed with an aperture for hand engagement, a picture or mirror being hung from said improved hanger, and selectively positionably located in abutting relationship against the wall, the location once determined, the picture or mirror being removed from said fixedly secured improved hanger, and the location of said fixedly secured improved hanger marked on said wall for receipt of separate improved hanger secured to said wall at said location.
